(19) United States
(12) Patent Application Publication
(10) Pub. No.: US 2005/0009505 A1
(43) Pub. Date: Jan. 13, 2005

(54) Communication network and method for suspending services

(75) Inventor: Guido Triebel, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/864,599

(22) Filed: Jun. 10, 2004

(30) Foreign Application Priority Data
Jul. 9, 2003 (GB) 0316080.1

(51) Int. Cl. H04M 1/66

(52) U.S. Cl. 455/411; 455/410

(57) ABSTRACT

A method of providing a service by a communication network is provided. According to one embodiment, the method includes the step of initiating the provision of the service to a first node. The method also determines if a condition is met for the first node. The method suspends the provision of the service if it is determined that the condition for the first node is not met. The method determines if the condition has been met by the first node and resumes the service provided by the communication network if it is determined that the condition for the first node is met.

### BACKGROUND OF THE INVENTION

1. Field of the Invention

The invention relates to the provision of services in a communications system and in particular, but not exclusively, to controlling the provision of services in accordance with payment by a user of the communications system.

2. Description of the Related Art

The introduction of Third Generation (3G) communication systems will significantly increase the possibilities for accessing services on the Internet via mobile user equipment (UE) as well as other types of UE.

Various user equipment (UE) such as computers (fixed or portable), mobile telephones, personal data assistants or organizers and so on are known to one skilled person and can be used to obtain services either via the Internet, or provided on the Internet. Mobile user equipment can be defined as a means that is capable of communication via a wireless interface with another device such as a base station of a mobile telecommunication network or any other station. Such a mobile user equipment can be adapted for voice, text message or data communication via the wireless interface.

The term “service” used in this discussion will be understood to broadly cover any service or goods which a user may desire, require or be provided with. The term “service” also will be understood to cover the provision of complimentary services. In particular, but not exclusively, the term “service” will be understood to include Internet multimedia services conferencing, telephony, gaming, rich call, presence, e-commerce instant messaging, multimedia messaging service (MMS), short messaging service (SMS), file (or music/application) browsing, streaming, downloading and content push and pull services.

The Third Generation Partnership Project (3GPP) defines a reference architecture for the Universal Mobile Telecommunication System (UMTS) core network which will provide the users of UE with access to these services. This UMTS core network is divided into three principal domains. These are the Circuit Switched domain, the Packet Switched domain and the Internet Protocol Multimedia (IM) domain.

In a communications system, a number of services may be available to a user of the communications system. For example users of the communication system may be able send text or multimedia messages. Services such as sending text or multimedia messages may be referred to as event based services. Users of the communication system may also be able to access session servers that provide the user with services such as Internet browsing and multimedia streaming. A session server may also allow the user to download a part of a file when another part of the file has already been downloaded and is in use by the user. Furthermore, a session server may provide generic data connectivity services such as speech data connections with another user. Such services may be referred to as session based services. It should be noted that the term “services” covers both session and event based services.

Of course, it may be necessary for a user to pay for the services provided by a network operator and other service providers of the communications system.

Some users may subscribe to a prepaid system for access to services offered by a network operator. This may involve the user purchasing a prepaid SIM card, which can be purchased off the shelf often without the need for a contract. A prepaid SIM card is associated with a prepay account. In order to use the services of the communications system with a prepaid SIM card, the associated prepay account must be paid in advance in order to establish a credit to use the services.

Alternatively the user may have a contract with a network operator and receive an invoice for the services that they have used during the billing period.

A further alternative method of payment for services provided by a network operator is by credit card. For example, if a user wishes to pay for a particular service such as requesting information from a server, the user may first pay for the information by inputting his credit card account information. After the credit card information has been verified, the requested information may be downloaded from the server. In this alternative, a user does not necessarily need to establish a contract with the operators or service providers, or even a phone. A user can establish a connection to a server, for example, using a public personal computer (PC) in an Internet cafe. Services may be paid later to a credit card issuer.

However if payment conditions are not met by a user, for example if the user has insufficient credit on a prepaid account to pay for a service, the service that the user is engaged in may be stopped by the network element providing the service. For example, if it is determined that a user who attempts to send a text message cannot pay for the message to be sent, the service is simply denied. Similarly, if it is determined that a user has insufficient credit to continue a session based service, the session may be torn down.

Denying or tearing down a service is not user friendly because the effort afforded by the user to initiate the service is wasted and, for example, partly transferred content (e.g. files) can be lost. Furthermore, if a user has deleted a message after attempting to send the message the message may be completely lost.

### SUMMARY OF THE INVENTION

According to a first embodiment of the invention there is provided a method of providing a service by a communication network. The method initiates the provision of the service to a first node to determine if a condition is met for the first node The method suspends the provision of the service if it is determined that the condition for the first node is not met. The method determines if the condition has been met by the first node. The method resumes the service provided by the communication network if it is determined that the condition for the first node is met.

According to a second embodiment of the invention there is provided a communication network. The network includes a device to initiate the provision of a service to a first node. The network also includes a determining mechanism for determining if a condition is met for the first node. The network includes a suspending mechanism arranged to suspending the provision of the service if it is determined that the condition for the first node is not met. The communication network may be arranged to resume the service provided by the communication network if it is determined that the condition for the first node is met.

According to a third embodiment of the invention there is provided a node in a communication network. The network may be arranged to transmit a request to determine if a condition is met for a first node during the provision of a service. The network may be arranged to receive notification of whether the condition is met and suspend the provision of the service if the condition is not met. The network may also be arranged to resume the provision of the service when the condition is met.

### BRIEF DESCRIPTION OF THE DRAWINGS

Embodiments of the invention will now be described by way of example only with reference to the accompanying drawings, in which:

FIG. 1 is a simplified presentation of a cellular network which may be employed in the embodiments of the invention;

FIG. 2 is a schematic diagram of a communication network in accordance with an embodiment of the invention;

FIG. 3 is a signaling diagram showing steps of a method in accordance with an embodiment of the invention;

FIG. 4 is a further schematic diagram of a communication network in accordance with an embodiment of the invention;

FIG. 5 is a signaling diagram showing steps of a method in accordance with a further embodiment of the invention;

FIG. 6 is a signaling diagram showing steps of a method in accordance with a further embodiment of the invention;

FIG. 7 is a signaling diagram showing steps of a method in accordance with a further embodiment of the invention;

FIG. 8 is a further schematic diagram showing part of a communication network in accordance with an embodiment of the invention; and

FIG. 9 is a further schematic diagram showing part of a communication network in accordance with an embodiment of the invention.

### DETAILED DESCRIPTION OF THE PREFERRED EMBODIMENTS

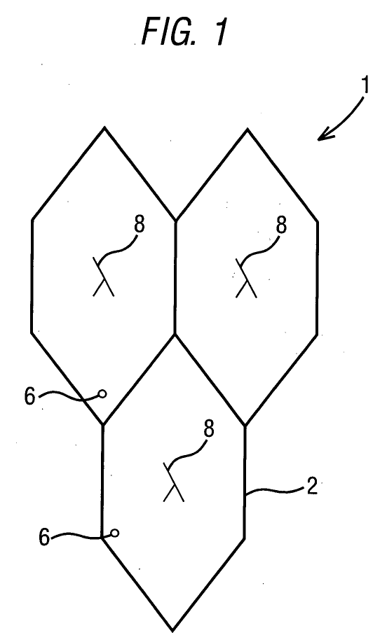

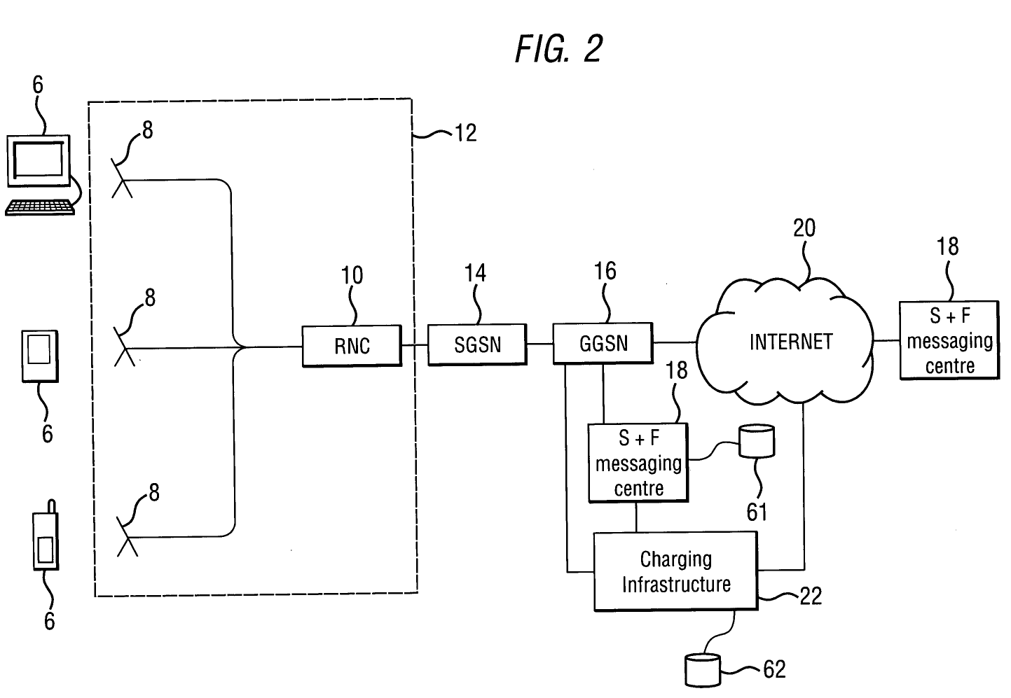

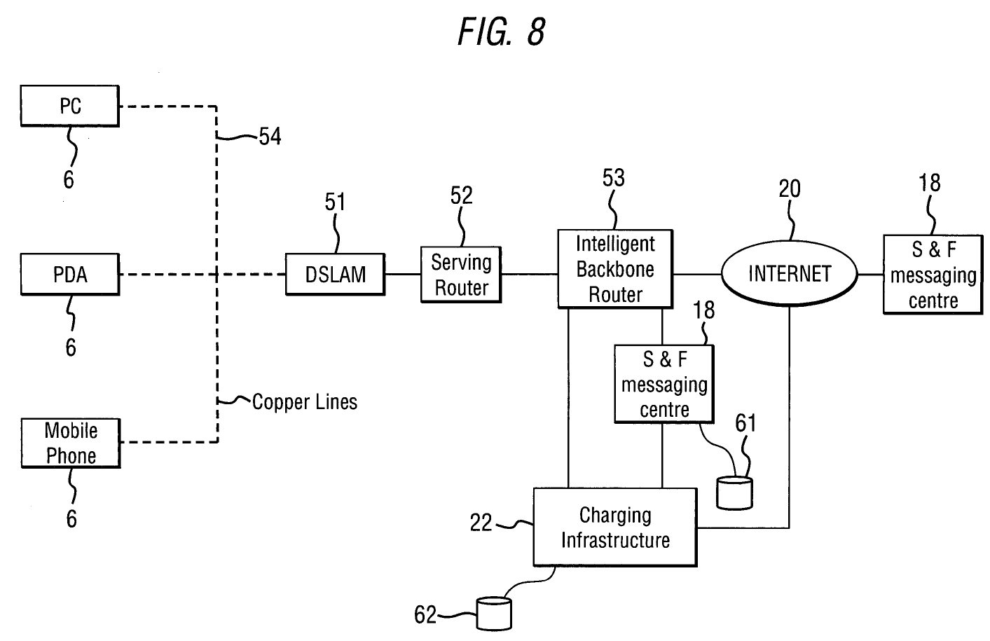

Reference will be made to two alternative network architectures which may be arranged in accordance with embodiments of the invention. Reference will first be made to a Third Generation (3G) Universal Mobile Telecommunications System (UMTS) and will be discussed in relation to the examples shown in FIGS. 1 and 2. A fixed network will then be discussed in relation to FIG. 8. However, it should be appreciated that the embodiments of the invention can be used in any other suitable form of network.

As discussed previously, the UMTS core network includes the IM domain. The IM domain guarantees that multimedia services are adequately managed. The IM domain supports the Session Initiation Protocol (SIP) as developed by the Internet Engineering Task Force (IETF).

SIP is an application layer signaling protocol for starting, changing and ending user sessions. A session may, for example, be a two-way telephone call or multi-way conference session or connection between a user and an application server AS. The establishment of these sessions enables a user to be provided with the above-mentioned services. One of the basic features of SIP is that the protocol enables personal mobility of a user using mobile UE by providing the capability to reach a called party (which can be an application server AS) via a single location independent address.

FIG. 1 shows an example of a simplified presentation of a cellular system showing an arrangement in which base stations 8 (only three shown for clarity) of the cellular system 1 provide radio coverage areas i.e. cells 2. Each radio coverage area 2 is typically served by a base station. One cell may include more than one base station site. A base station apparatus or site may also provide more than one cell. The shape and size of the cells 2 depend on the implementation and may be different from the illustrated shapes. In some systems the base station may be referred to as Node B.

Two user equipment (UE) 6 are also shown. Typically a number of user equipment will be in communication with each base station. Each base station may be arranged to transmit signals to and receive signals from the mobile user equipment (UE) 6 via a wireless interface. Likewise, the user equipment 6 may be arranged to transmit signals to and receive signals from the base stations.

Each of the base stations may be connected to an access network controller such as a radio network controller (RNC) 10 of a UMTS terrestrial radio access network (UTRAN) (shown in FIG. 2). The radio network controller may be connected to appropriate core network entities of the cellular system, such as an SGSN (serving general packet radio service support node) 14 for packet switched communication and additionally an MSC (mobile switching center) for circuit switched communication.

FIG. 2 depicts part of the architecture of a UMTS (universal mobile telecommunications network) arranged in accordance with an embodiment of the invention. FIG. 2 shows a plurality of user equipment 6 such as PDAs (Personal Digital Assistants), mobile phones and laptops; a radio access network (RAN) 12 including base stations 8 and an RNC (radio network controller) 10; an SGSN (serving GPRS support node) 14; a GGSN (gateway GPRS support node) 16; an S and F (store and forward) messaging center 18; and a charging infrastructure 22. The Internet is depicted by reference 20. In the embodiment shown in FIG. 2 the S and F messaging center 18 is shown as being directly connected to an operator's GPRS domain via the GGSN 16. In an alternative embodiment, the S and F messaging center may be connected to an operator's GGSN through the Internet. The Charging infrastructure may be connected to an S and F messaging center 18, the GGSN 16 and the Internet 20.

The implementation of the RAN 12, SSGN 14 and GGSN 16 are well known in the art, and for the purposes of the discussion of embodiments of the invention it is assumed that they operate in accordance with standard, known techniques except where stated.

FIG. 8 illustrates an example of a fixed network arranged in accordance with the invention. FIG. 8 depicts part of the architecture of a fixed network arranged in accordance with a further embodiment of the invention. This figure shows a plurality of user equipment 6 such as mobile phones, personal computers and PDAs connected via fixed copper lines 54 to a Digital Subscriber Line Access Multiplexer (DSLAM) 51. A mobile phone may be connected to a copper line using an interface port. In order for the UE 6 to establish a digital connection with the DSLAM each UE may include a DSL modem. The UE may be attached to the copper lines 54 by an access port which may be provided at a fixed location. The DSL network may further include a Serving Router 52, an Intelligent Backbone Router 53, an S and F messaging center 18 and a charging infrastructure 22. Again, the Internet is depicted by reference 20. In FIG. 8 the S and F messaging center 18 is shown as connected between the Intelligent backbone router and the charging infrastructure 22. The Intelligent backbone router may also be directly connected to the charging infrastructure. In an alternative embodiment, the S and F messaging center may also be connected to a network operators Intelligent Backbone router through the Internet. In addition to being connected to the Intelligent backbone router and an S and F messaging center, the Charging Infrastructure may also be connected to the Internet.

The implementation of the DSLAM 51, Serving Router 52 and Intelligent Backbone router 53 of a fixed network are well known in the art, and for the purposes of the discussion of embodiments of the invention it is assumed that they operate in accordance with standard known techniques except where stated.

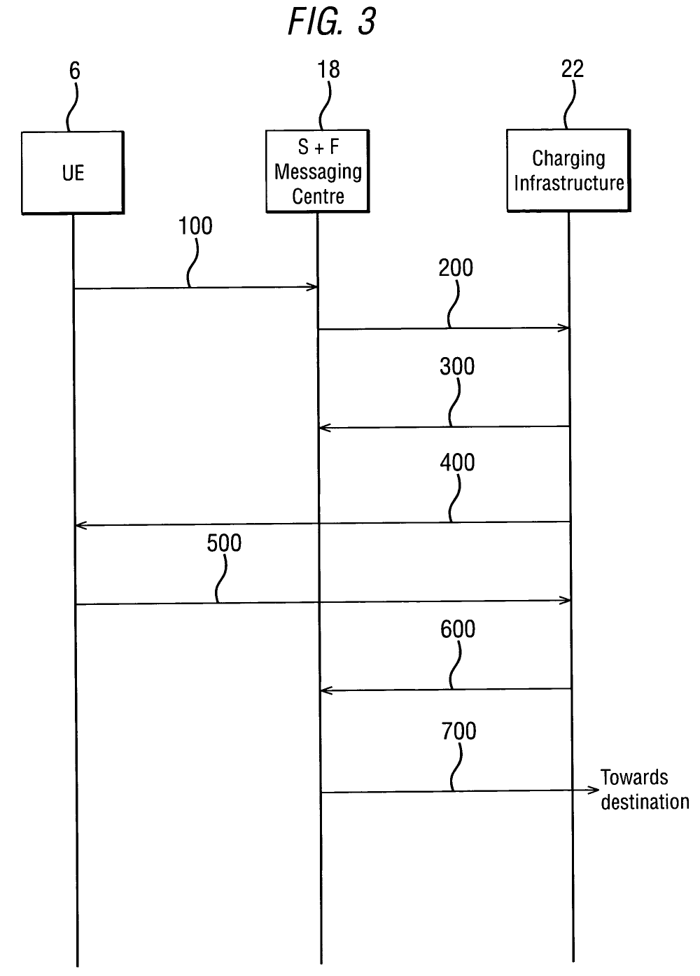

FIG. 3 shows the signaling between a user terminal 6, an S and F messaging center 18 and the charging infrastructure 22, in accordance with an embodiment of the invention. The signaling shown in FIG. 3 may be implemented in both the fixed and UMTS network arrangements discussed previously, in addition to any other suitable form of network.

In order to transmit a message such as an SMS (Short Message Service) message, the message may be transmitted from UE 6 to the messaging center 18 by signal 100. On receipt of signal 100 the messaging center sends, by signal 200, a request to the charging infrastructure 22 to verify that the payment for sending the message may be met.

In one embodiment of the invention, signal 200 contains a unique message identification number (ID). The message ID number may be inherent in the message such that it is defined by information present in the message. For example, the message ID may be derived from the International Mobile Subscriber Identity (IMSI) number of the UE sending the message. Alternatively the message ID number may be generated in the messaging center or in the charging infrastructure.

In a further embodiment of the invention the signal 200 may additionally, or alternatively contain a user ID, such as the IMSI number of the user.

In a further embodiment of the invention, the signal 200 may additionally contain information identifying the type of message being sent by the UE. For example, if the message is a SMS to a premium rate number for entering a competition, this may have a particular ‘type ID’ which differs from a message that is sent for paying for a service, or for sending an SMS to another UE.

In an alternative embodiment of the invention signal 200 may initiate a session between the S and F messaging center and the charging infrastructure.

The manner in which the charging infrastructure will determine if payment for transmitting the message can be met will depend on the method of payment used to send the message. If the user is a subscriber with a prepaid account, the charging infrastructure may use the user ID to check the balance of the user's prepaid account to determine whether the balance of the account is sufficient to cover the cost of sending the message. Alternatively if the user has a contract with the network operator by which the user may pay for a service after they have used the service, the charging infrastructure may use the user ID to determine if the outstanding balance which the user owes the network operator exceeds a predefined threshold. The charging infrastructure may alternatively determine whether the user defaulted on a previous payment due to the network operator. If the user has previously provided credit card account information for sending the message the charging infrastructure may determine whether the credit card used is valid, and whether the credit limit of the credit card is sufficient to cover the cost of sending the message. The above mentioned methods of payment are not exhaustive and in alternative embodiments of the invention, further methods of payment may be used.

A user may have a plurality of accounts for different services which are debited depending upon the type of services requested. For example a user may have separate accounts in order to pay for services such as making voice calls, sending SMS messages to other UEs, sending messages for paying for services and for sending messages for entering competitions. Organizing the accounts of a user in this manner is known in the art as a ‘mobile wallet’. Therefore in a further embodiment of the invention if a user operates a mobile wallet, the charging infrastructure may decide which account to check by referring to the type ID contained in the message.

If it is determined by the charging infrastructure that payment for sending the message may be met, the charging infrastructure notifies the messaging center 18 that the payment conditions are met. This may be performed by instructing the messaging center 18 during the session initiated by signal 200 to forward the message to which the session relates. Alternatively, if a session was not created between the messaging center and the charging infrastructure, the charging infrastructure sends a signal to the messaging structure that includes the message ID. This allows the messaging center to identify the message to be forwarded.

After receiving a signal from the charging infrastructure indicating that payment conditions are met, the messaging center 18 may forward the message from the UE to the destination that has been specified by the user.

If however it is determined by the charging infrastructure that payment for sending the message cannot be met, the charging infrastructure 22 may send a signal 300 to the messaging center 18 instructing the messaging center to hold the message in a database 61 until further notification. Again, this maybe done by instructing the messaging center 18 during the session initiated by signal 200 to hold the message to which the session relates. Alternatively, if a session was not created between the messaging center and the charging infrastructure, the charging infrastructure will include the message ID in signal 300 to allow the messaging center to identify the message to be held.

In an embodiment of the invention if it is determined that payment for sending the message cannot be met, the charging infrastructure stores the message ID together with the user ID in a database 62.

Databases 61 and 62 may be included in the messaging center and the charging infrastructures respectively, or may be separate entities. The message may be stored in database 61 for a predetermined time. The predetermined time may be set by the network operator or may depend upon the type of message being sent. In a preferred embodiment of the invention the charging infrastructure then sends a message 400 to the UE 6, prompting the user for payment. Message 400 may be sent from the charging infrastructure to the UE in the form of an SMS message, an MMS (Multimedia Messaging Service) message, an OMA (Open Mobile Alliance) push or an SIP (Session Initiation Protocol) push.

In response to the prompt for payment, the user may decide whether or not to pay to send the message. If the user decides to ignore the prompt for payment and not pay for sending the message, the message that the user was attempting to send may be held at database 61 of the messaging center until the predetermined time has expired, after which the message may be deleted from the database.

However, if the user decides to pay for sending the message, the user may provide payment details to the charging interface in signal 500. Signal 500 may further include a user ID such as an IMSI number. The payment details sent by the user may increase the credit of a prepaid account to a sufficient amount. Alternatively, if the user is party to a contract with the network operator, the user may request that the billing threshold be increased to sufficiently cover the payment for sending the message. If the charging interface determined that a credit card used to pay for sending the message is invalid, the user may provide alternative credit card information. Alternatively the user may select an alternative method of payment instead of the method in which the payment conditions were determined to be insufficient. Embodiments of the invention are not restricted to the above mentioned methods of payment. In further embodiments of the invention, alternative methods of payment may be used.

Using the user ID in signal 500 the charging infrastructure 22 may refer to database 62 to identify the message ID of the message which the user is paying to send. In one embodiment of the invention the user may have a plurality of messages held at database 61 of the messaging center. A plurality of message IDs may therefore be stored in database 62 of the charging infrastructure that relate to the same user ID.

After receiving the payment details from the UE 6, the charging infrastructure determines whether payment for sending the message can be met using the payment details supplied in signal 500. If it is determined that payment can now be met the charging infrastructure may send a signal 600 to the messaging center 18 instructing the messaging center to retrieve the message identified by the message ID from the database 61 and to forward the message to the destination specified in the message.

Accordingly upon receiving signal 600 the messaging center 18 retrieves the message identified by the message ID from the database. The message is then sent as message 700 to the destination specified in the message.

In an alternative embodiment of the invention the message 400 sent from the charging infrastructure to the UE for prompting the UE for payment details may instead be sent from the messaging center, after the messaging center has received signal 300 along with instructions to store the message.

In an alternative embodiment of the invention the user derived message may be a multimedia message.

In alternative embodiments of the invention signals 400 and 500 are not sent to and from the UE which is attempting to send a message. In one embodiment of the invention, signal 400 may be sent to a UE registered to a different user. The different user may be a member of the same ‘Family Account’ as the user attempting to send the message. A Family Account may be defined as an account which accumulates the charges for a number of users having different user equipment, but is controlled by one user. The different user may then send signal 500 to supply payment details.

Alternatively, in a further embodiment of the invention signals 400 and 500 are not sent. Instead the charging infrastructure may detect when the user has credited their account without being prompted by signal 400. For example the charging infrastructure may detect if the user has credited their account with a payment after receiving a monthly invoice. Alternatively, the charging infrastructure may detect if a user has credited a prepaid account. Once payment conditions have been met the charging infrastructure may send signal 600 to the messaging center as described above.

In one embodiment of the invention the user may have a plurality of messages held at database 61 of the messaging center which may have accumulated during a period when the user was not able to meet payment for sending the messages. A plurality of message IDs will therefore be stored on database 62 of the charging infrastructure that relate to the same user ID. When the charging infrastructure detects that a user having a user ID has credited their account, the charging infrastructure may send signal 600 to the messaging center containing all, or some of the message IDs that correspond to that user.

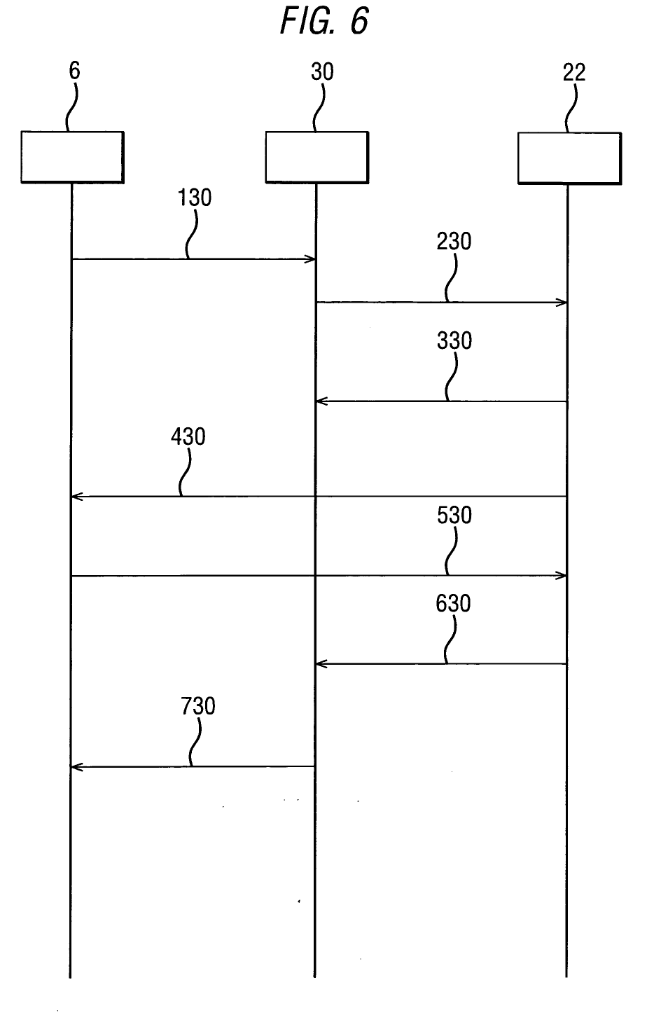

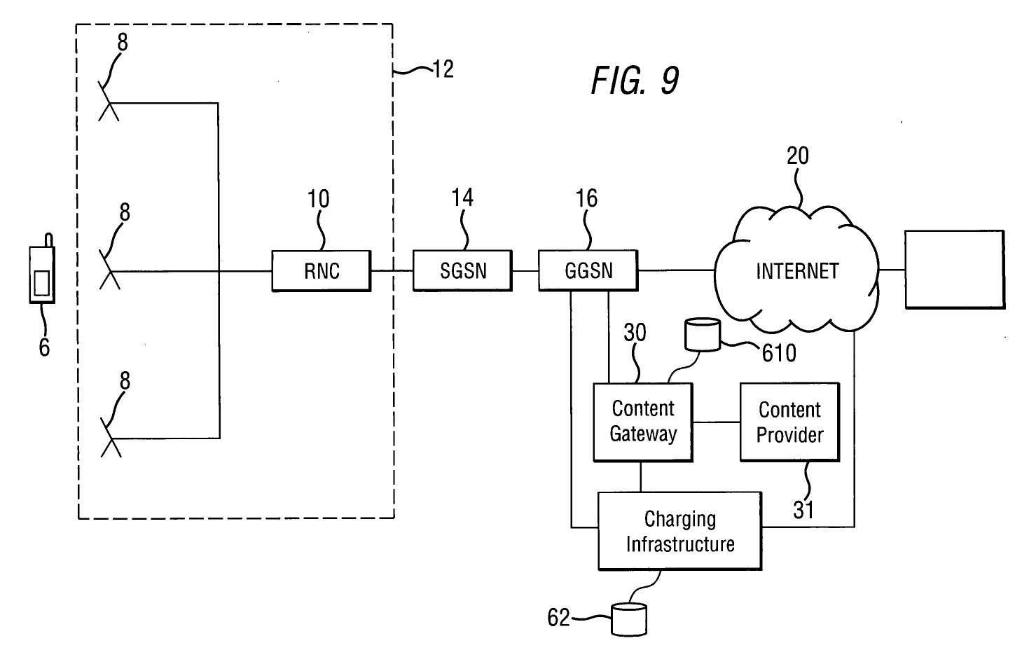

In a further alternative embodiment of the invention the user derived message may be a message requesting content from a content provider. This embodiment will be discussed in relation to FIGS. 6 and 9.

FIG. 9 depicts an example of a part of a UMTS network arranged in accordance with the invention. The elements shown in the example of FIG. 9 are the same as FIG. 2 with the exception that FIG. 9 further includes a content gateway 30 having a database 610 and a content provider 31.

FIG. 6 shows an example of signaling between a UE 6, a content gateway 30, and a charging infrastructure 22. UE 6 sends a content request message 130 to the content gateway 30. On receipt of content request message 130 the content gateway 30 sends, by signal 230, a request to the charging infrastructure 22 to verify that the payment for providing content from the content provider may be met. In one embodiment of the invention, signal 230 contains a unique message identification number (ID) of the content request message. The message ID may be inherent in the message such that it is defined by information present in the message. Alternatively the ID number may be generated in the content gateway 30 or in the charging infrastructure 22.

In a further embodiment of the invention, the signal 230 may additionally contain information identifying the type of content being requested by the UE. This may be identified by a type ID.

In an alternative embodiment of the invention signal 230 may initiate a session between the content gateway and the charging infrastructure.

As described earlier the manner in which the charging infrastructure determines whether the payment conditions are met may depend on the payment method used. If it is determined by the charging infrastructure that the payment for providing content has been met, the charging infrastructure notifies the content gateway that the payment conditions have been met. This maybe done by instructing the content gateway 30 during the session initiated by signal 200 to forward the message to which the session relates. Alternatively, if a session was not created between the content gateway and the charging infrastructure, the charging infrastructure sends a signal to the content gateway that includes the message ID. This allows the content gateway to identify the message to be forwarded.

After receiving a message from the charging infrastructure indicating that the payment conditions have been met, the content gateway forwards the message from the UE to the content provider. The content provider may then provide the UE with the requested content.

If however it is determined by the charging infrastructure that the payment for providing the content cannot be met, the charging infrastructure 22 sends a signal 330 to the content gateway instructing the content gateway to hold the message in a database 610 until further notification. Again, this maybe done by instructing the content gateway 30 during the session initiated by signal 230 to hold the message to which the session relates. Alternatively, if a session was not created between the content gateway 30 and the charging infrastructure 22, the charging infrastructure may include the message ID in signal 330 to allow the content gateway to identify the message to be held.

Again, in an embodiment of the invention if it is determined that payment for sending the message cannot be met, the charging infrastructure stores the message ID together with the user ID in a database 62. Databases 610 and 62 may be included in the content gateway and charging infrastructure respectively, or may be separate entities.

The message 130 may be stored in database 610 for a predetermined time. The predetermined time may be set by the network operator or in dependence of the type of content requested.

In an embodiment of the invention the charging infrastructure then sends a message 430 to the UE 6, prompting the user for payment. Message 430 may be sent from the charging infrastructure to the UE in the form of an SMS message, an MMS message, an OMA push or an SIP push. In alternative embodiments of the invention message 430 may be in a different form than those listed above.

In response to the prompt for payment, the user may decide whether or not to pay for the requested content. If the user decides to ignore the prompt for payment and not pay for the content, the content request message may be held at database 610 of the content gateway until the predetermined time has expired, after which the content request message may be deleted from the database.

However, if the user decides to pay for the content, the user may provide payment details to the charging interface in signal 530, which further includes the user ID. Payment details may be provided in any of the methods described above in relation to FIG. 3. However, embodiments of the invention are not restricted to such methods of payment. In further embodiments of the invention, alternative methods of payment may be used.

Using the user ID in signal 530 the charging infrastructure 22 may refer to database 62 to identify the message ID of the message sent by the user to request content. In one embodiment of the invention the user may have a plurality of messages held at database 610 of the content gateway. A plurality of message IDs may therefore be stored on database 62 of the charging infrastructure that relate to the same user ID.

After receiving the payment details from the UE 6, the charging infrastructure determines whether payment can be met using the payment information supplied in signal 530. If it is determined that payment can now be met the charging infrastructure may send a signal 630 to the content gateway instructing the content gateway to retrieve the message identified by the message ID from the database and to forward the message to the content provider.

Upon receiving signal 630, the content gateway retrieves the message identified by the message ID from the database 610. The content request message is then forwarded to the content provider. The content gateway may then fetch the requested content from the content provider and provide the UE with the requested content as represented by signal 730.

As described in relation to sending a message via an S and F messaging center, in alternative embodiments of the invention the message sent to the UE prompting the user for payment may not be sent, or may be sent to a different UE which may be a member of the same family account.

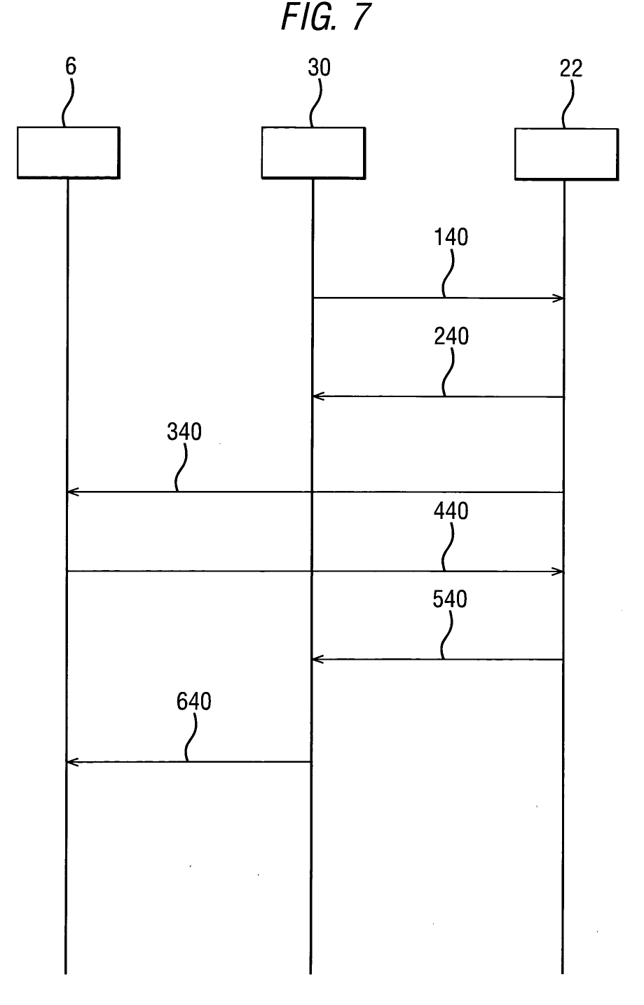

In a further alternative embodiment of the invention the provision of a service to the user may be initiated by the network. For example if the user is registered to a service for providing the user with news updates, information may be sent from a content provider in the form of a SMS. The information may be sent to the user at predefined times, or when there is new information available. This embodiment of the invention described in relation to FIG. 7.

FIG. 7 shows an example the signaling between a UE 6, a content gateway 30, and a charging infrastructure 22.

When information is to be sent to a UE 6, the content provider sends the information to the content gateway 30. The information sent from the content provider may be given a message ID. Upon receiving the information the content gateway 30 may send, by signal 140, a request to the charging infrastructure 22 to verify that the payment for providing content from the content provider may be met. Signal 140 contains the user ID relating to the UE for which the information is intended together with the message ID of the content information. If it is determined by the charging infrastructure that the payment for providing content have been met, the charging infrastructure notifies the content gateway that the payment conditions have been met. Again, the charging infrastructure may notify the content gateway during a session or the charging infrastructure may identify the content information message to be forwarded using the message ID in the notification. After receiving a signal from the charging infrastructure indicating that the payment conditions have been met, the content gateway then forwards the information from the content provider to the UE.

If however it is determined by the charging infrastructure that the payment for providing the content cannot be met, the charging infrastructure 22 sends a message 240 to the content gateway instructing the content gateway to hold the content information message in a in database 610 for a predetermined time until further notification. Additionally, the charging infrastructure stores the message ID together with the user ID in database 62.

The charging infrastructure then sends a message 340 to the UE 6, prompting the user for payment. Message 340 may be sent from the charging infrastructure to the UE in the form of an SMS message, an MMS message, an OMA push or an SIP push. In alternative embodiments of the invention message 340 may be in a form different than those listed above.

In response to the prompt for payment, the user may decide whether or not to pay for the content. If the user decides to ignore the prompt for payment and not pay for the content, the content information message may be held at the database of the content gateway until the predetermined time has expired, after which the content information message may be deleted from the database.

However, if the user decides to pay for the content, the user may provide payment details to the charging interface in message 440, in any of the methods described above in relation to FIG. 3. However, embodiments of the invention are not restricted to such methods of payment. In further embodiments of the invention, alternative methods of payment may be used.

After receiving the payment details from the UE 6, the charging infrastructure determines whether payment can be met using the payment information supplied in message 440. If it is determined that payment can now be met the charging infrastructure sends a signal 540 to the content gateway instructing the content gateway to retrieve the content identified by the message ID from database 610 and to forward the message to the UE.

Upon receiving message 540 the content gateway retrieves the message identified by the message ID from the database. The content message is then forwarded to the UE as represented by signal 640.

Again, in alternative embodiments of the invention the message sent to the UE prompting the user for payment may not be sent, or may be sent to a different UE which may be a member of the same family account.

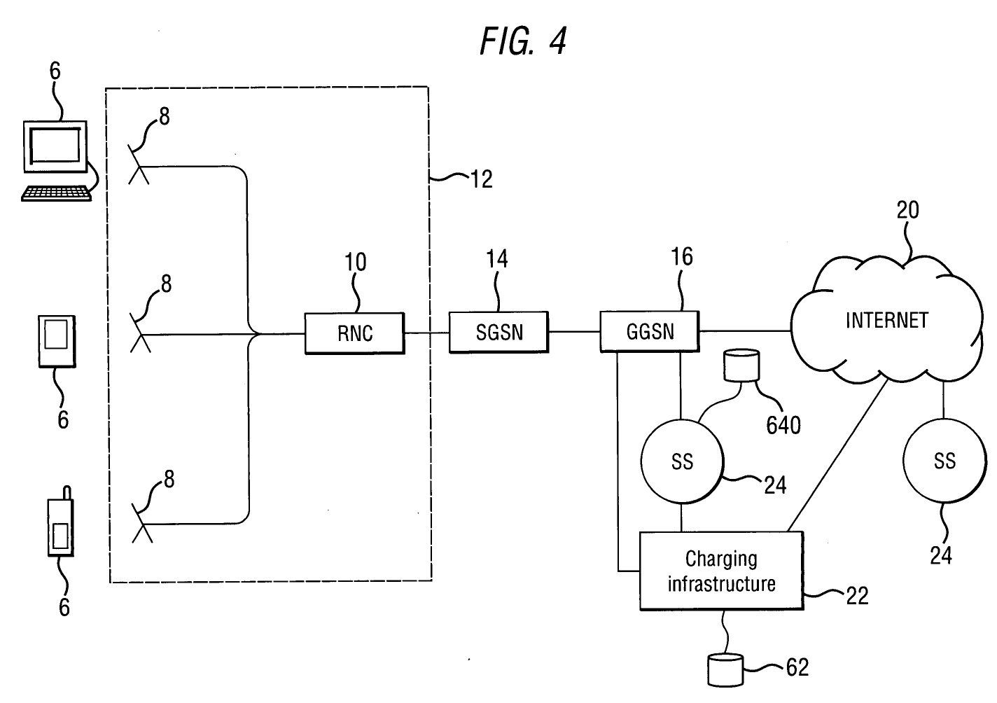

Reference is now made to FIG. 4. FIG. 4 depicts part of the architecture of a UMTS (universal mobile telecommunications network) in which a further embodiment of the invention may be implemented. The elements of FIG. 4 that are the same as those shown in FIG. 2 are denoted by like reference numerals. In addition to the elements shown in FIG. 2, FIG. 4 further includes a session server 24. The session server 24 is connected to the GGSN 16 and to the charging infrastructure 22. In an alternative embodiment, the session server 24 may be connected to an operator's SGSN through the Internet 20. The charging infrastructure 22 is connected to the GGSN 16, the session server 24 and the internet 20.

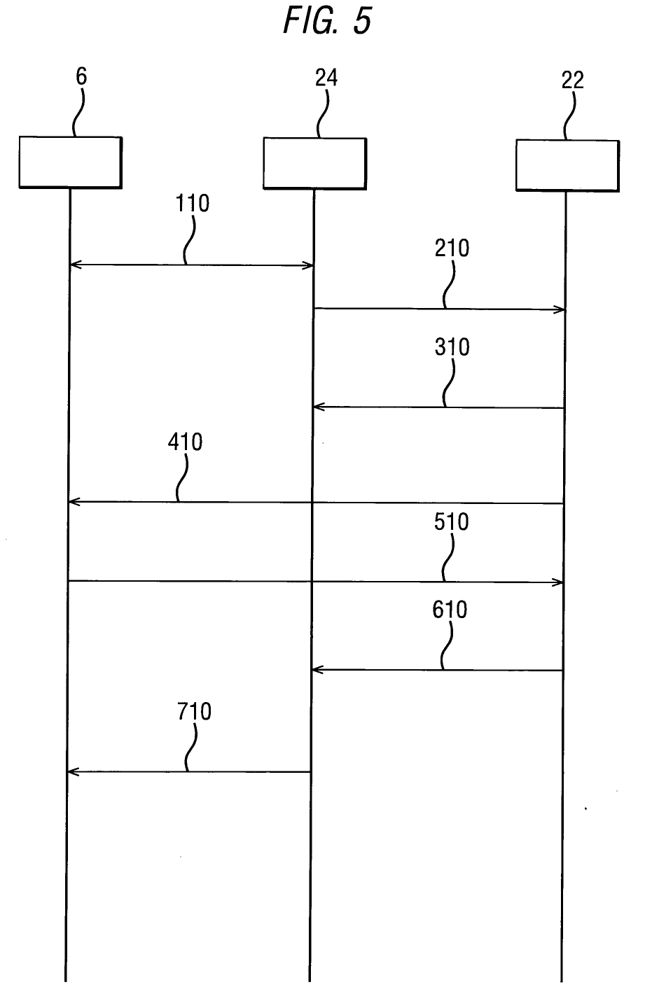

FIG. 5 shows the signaling between a user terminal 6, a session server 24 and the charging infrastructure 22, in accordance with a further embodiment of the invention.

Signal 110 shown in FIG. 5 represents that session server 24 is initially in communication with user equipment 6. The session may divided into a plurality of session units that may be measured in units of time, data or session events. This allows the session server to send a signal 210 to the charging infrastructure to request payment for one, or a predetermined number of session units, or to request the charging infrastructure to verify that the payment for a predetermined number of session units may be met.

In one embodiment of the invention, signal 210 may contain a unique session identification number (ID). The session ID number may be inherent in the session such that it is defined by information present in the session. Alternatively the session ID number may be generated in the session server or in the charging infrastructure.

In a further embodiment of the invention the signal 210 may additionally, or alternatively, contain information identifying the UE, such as the IMSI number of the user.

In a further embodiment of the invention, the signal 210 may additionally contain information identifying the type of session that is in place between the UE and the session server. The type of session may be identified by a type ID.

In an alternative embodiment of the invention signal 210 may initiate a session between the session server and the charging infrastructure.

The signal 210 may be sent before any session units are sent to the UE, and after a predetermined number of session units have been sent to the UE, in order to verify payment for subsequent session units.

As described in relation to determining payment conditions for transmitting a message, the manner in which the charging infrastructure determines whether payment for transmitting the session can be met may depend on the method of payment used for the session. Again, if the user is a subscriber with a prepaid account, the charging infrastructure may check the balance of the user's prepaid account to determine whether the balance of the account is sufficient to cover the cost of sending the message. Alternatively if the user has a contract with the network operator by which the user may pay for a service after they have used the service, the charging infrastructure may determine if the outstanding balance which the user owes the network operator exceeds a predefined threshold. The charging infrastructure may alternatively determine whether the user defaulted on a previous payment due to the network operator. If the user pays for the session service by credit card the charging infrastructure may determine whether the credit card used is valid, and whether the credit limit of the credit card is sufficient to cover the cost of the session.

If the user operates a mobile wallet as discussed above, the charging infrastructure may decide which of the users accounts to check by referring to the type ID contained in signal 210.

If it is determined by the charging infrastructure that the user is able to pay for the predetermined number of session units, the charging infrastructure 22 notifies the session server 24 that the payment conditions are met for the predetermined number of session units. This may be done by instructing the session server during the session between the session server and the charging infrastructure, initiated by signal 210, to maintain the session with the user, to which the session with the charging infrastructure relates. Alternatively, if a session was not created between the session server and the charging infrastructure, the charging infrastructure sends a signal to the session server that includes the session ID. This allows the session server to identify the session to be maintained.

After receiving a signal from the charging infrastructure indicating that payment conditions are met for the predetermined number of session units, the session server 24 maintains the session with the user 6 for the predetermined number of session units. After the UE has been provided with the predetermined number of session units a further signal 210 may be sent from the session server to the charging infrastructure to request payment verification for a subsequent predetermined number of session units.

If however it is determined by the charging infrastructure that payment for the session cannot be met, the charging infrastructure 22 sends a signal 310 to the session server 24 instructing the session server to interrupt the session with the user until further notification. Again, this may be done by instructing the session server, during the session with the charging infrastructure initiated by signal 210, to suspend the session with the UE to which the session with the charging infrastructure relates. Alternatively, if a session was not created between the session server and the charging infrastructure, the charging infrastructure will include the session ID in signal 310 to allow the session server to identify the session to be suspended.

In an embodiment of the invention if it is determined that payment for the session cannot be met, the charging infrastructure stores the session ID together with the user ID in a database 62. The session may be suspended for a predetermined time. The predetermined time may be set by the network operator, may depend upon the type of session in progress, may be limited by the session protocol used or may depend upon the subscriber profile of the user. A subscriber profile may be defined as information relating to a particular subscriber to the network indicating the level of service offered to the subscriber.

As described earlier, the session may be identified by a session ID. According to one embodiment, during the predetermined time the session may not be stopped, because if a session is stopped it may not be resumed. Instead, during the predetermined time the session may be active, but suspended. The session server keeps the session open and online for the predetermined time and remains aware of the a charging session ID. In an embodiment of the invention the session server may store the session ID in a database 640 (see FIG. 4). Database 640 may form part of the session server or may be a separate entity from the session server.

In an embodiment of the invention, the charging infrastructure then sends a message 410 to the UE 6, prompting the user for payment. Message 410 may be sent from the charging infrastructure to the UE in the form of an SMS message, an NMS (Multimedia Messaging Service) message, an OMA push, an HTTP (Hypertext Transfer Protocol) or an SIP (Session Initiation Protocol) push. In further embodiments of the invention message 410 may be sent to the UE in alternative forms to those listed above.

In response to the prompt for payment, the user may decide whether or not to pay in order to allow the suspended session to be resumed. If the user decides to ignore the prompt for payment and not pay for the session, the session may remain in a suspended state on session server until the predetermined time has expired, after which the session may be stopped.

However, if the user decides to pay for the session, the user may provide payment information to the charging interface in signal 510. Signal 500 further includes the user ID. The payment details sent by the user may increase the credit of a prepaid account to a sufficient amount. Alternatively, if the user is party to a contract with the network operator, the user may request that the billing threshold is increased to sufficiently cover the payment for the session. If the charging interface determined that a credit card used to pay for the session is invalid, the user may provide alternative credit card information. Alternatively the user may select an alternative method of payment instead of the method in which payment conditions were determined to be insufficient.

Using the user ID in signal 510 the charging infrastructure 22 may refer to database 62 to identify the session ID of the session which the user is paying to resume.

After receiving the payment information from the UE 6, the charging infrastructure may determine whether the payment can be met using the payment information supplied in signal 510. If it is determined that payment can now be met, the charging infrastructure sends a signal 610 to the session server instructing the session server to resume the session with reference to the session ID.

Upon receipt of signal 610, the session server may resume the session identified by the session ID with the user equipment 6. This is represented in FIG. 5 by signal 710.

In an alternative embodiment of the invention, after the session has received message 310 with instructions to suspend the session, the message 410 sent from the charging infrastructure to the UE for prompting the UE for payment details may instead be sent from the session server. For example, in an embodiment of the invention the session server may be a server which provides browsing services. The session server may therefore be accessed via a browsing gateway. In this embodiment of the invention the charging infrastructure may send a message to the browsing gateway indicating that the session has been suspended. The user may then be prompted to provide payment information by the browsing gateway by redirecting the user to a notification page that prompts the user for payment.

Again, in alternative embodiments of the invention the message sent to the UE prompting the user for payment may not be sent, or may be sent to a different UE which may be a member of the same family account.

In an alternative embodiment of the invention the session server may provide streaming services. If an off band messaging mechanism is available with streaming technology, the streaming server may send message 410 to the UE over the off band messaging mechanism, prompting the user for payment. An off band messaging mechanism may be a separate connection that the streaming server has with the UE from the connection used to stream information.

If the session server provides generic data connectivity services, such as speech connectivity, it is desirable for both the method of prompting the user for payment information and the method for the user to provide payment information to be fast, and ideally faster than the time taken for the user to disconnect and reconnect the call. An example of such a method may be to provide back-up payment information to the network operator, such as alternative credit card information, before attempting to use a service. Alternatively if the user has a contract with the network operator that specifies a threshold credit limit for an outstanding balance of the user's account, a new credit limit may be specified in the prompt of message 410 to the user, which simply needs to be confirmed by the user.

Embodiments of the invention have been described with specific reference to the UMTS and GPRS systems. However, it is not limited to these systems.

The applicant draws attention to the fact that the invention may include any feature or combination of features disclosed herein either implicitly or explicitly or any generalization thereof, without limitation to the scope of any of the present claims. In view of the foregoing description it will be evident to a person skilled in the art that various modifications may be made within the scope of the invention.

1. A method of providing a service by a communication network, comprising the steps of:
initiating the provision of the service to a first node;
determining if a condition is met for said first node;
suspending the provision of said service if a determination is made that the condition for said first node is not met;
determining if the condition has been met by the first node; and
resuming the service provided by a communication network if a determination is made that the condition for the first node is met.

2. A method as claimed in claim 1 further comprising the step of:
requesting that the first node meets the condition.

3. A method as claimed in claim 1 further comprising the step of:
providing said service by a second node.

4. A method as claimed in claim 1 wherein said step of determining if said condition is met is provided by a third node.

5. A method as claimed in claim 1 further comprising the step of:
initiating the provision of the service by sending a first message from said first node.

6. A method as claimed in claim 3 further comprising the step of:
initiating the provision of the service by establishing a session between the first node and the second node.

7. A method as claimed in claim 3 further comprising the step of:
initiating the provision of the service by sending a message from the second node.

8. A method as claimed in claim 4 further comprising the step of:
sending a signal to the third node to request that said third node determines if said condition is met.

9. A method as claimed in claim 4 further comprising the step of:
sending a signal from the third node to said second node to request that said second node suspends said service if the determination is made that said condition is not met.

10. A method as claimed in claim 2 further comprising the step of:
sending a signal to said first node to request that the first node meets the condition.

11. A method as claimed in claim 2 further comprising the step of:
sending a signal is sent to a further node different than the first node to request that the first node meets the condition.

12. A method as claimed in claim 10 wherein the step of sending comprises transferring using a push mechanism, the signal sent to the first node to request that the first node meets the condition .

13. A method as claimed in claim 4 further comprising the step of:
sending a signal from the first node to said third node including information to meet said conditions.

14. A method as claimed in claim 4 further comprising the step of:
sending a signal from said third node to said second node requesting that said second node resumes said service, if the determination is made that said condition is met.

15. A method as claimed in claim 3 further comprising the step of:
generating a service identification to identify the service provided to the first node.

16. A method as claimed in claim 5 further comprising the step of:
assigning a service identification to the message sent from the first node

17. A method as claimed in claim 6 further comprising the step of:
assigning a service identification to the session established between the first node and the second node.

18. A method as claimed in claim 7 further comprising the step of:
assigning a service identification to the message sent from the second node.

19. A method as claimed in claim 15 wherein the step of generating comprises generating the service identification by the second node.

20. A method as claimed in claim 15 wherein the step of generating comprises generating the service identification by the third node.

21. A method as claimed in claim 14 wherein the step of sending the signal from the third node to the second node comprises referring to a service identification.

22. A method as claimed in claim 15 further comprising the step of:
storing the service identification at the third node.

23. A method as claimed in claim 15 wherein the step of storing comprises storing the service identification in association with a user identification at the third node.

24. A method as claimed in claim 23 further comprising the step of:
identifying the subscriber of the first node using the user identification.

25. A method as claimed in claim 15 further comprising the step of:
storing the service identification is stored in association with a suspended service at the second node.

26. A method as claimed in claim 1 wherein the step of initiating comprises initiating the provision of the service of said first node comprising at least one of a mobile station, a Personal Digital Assistant and a Personal Computer.

27. A method as claimed in 3, wherein said step of providing comprises providing the service by said second node comprising at least one of a messaging center, a content gateway, an application server and a session server.

28. A method as claimed in claim 4 wherein the step of determining comprises determining by the third node comprising a charging infrastructure.

29. A method as claimed in claim 1 wherein the step of resuming comprises resuming the service provided by the communication network comprising a cellular communication network.

30. A method as claimed in claim 1 wherein the step of resuming comprises resuming the service by the communication network comprising a fixed network.

31. A method as claimed in claim 1 wherein the step of resuming comprises resuming the service provided by the communication network comprising an event based service.

32. A method as claimed in claim 1 wherein the step of resuming comprises resuming the service provided by the communication network comprising a session based service.

33. A method as claimed in claim 1 wherein the step of determining comprises determining the condition comprising a payment condition.

34. A communication network comprising:
initiating means for initiating a provision of a service to a first node;
determining means for determining if a condition is met for said first node; and
suspending means for suspending the provision of said service if a determination is made that the condition for said first node is not met;
wherein a communication network is arranged to resume the service provided by the communication network if a determination is made that the condition for the first node is met.

35. A communication network as claimed in claim 34, further comprising:
requesting means for requesting that the first node meets the condition.

36. A communication network as claimed in claim 34 further comprising:
requesting a second node arranged to provide said service.

37. A communication network as claimed in claim 36 wherein said second node comprises a storage means for storing a service identification in association with a suspended service.

38. A communication network as claimed in claim 34 wherein said determining means is provided by a third node.

39. A communication network as claimed in claim 38 wherein the third node further comprises storage means for storing a service identification in association with a user identification.

40. A communication network as claimed in claim 34 wherein the first node comprises at least one of a mobile station, a personal digital assistant and a personal computer.

41. A communication network as claimed in claim 36 wherein the second node comprises at least one of a messaging center, a content gateway, an application server and a session server.

42. A communication network as claimed in claim 38 wherein the third node comprises a charging infrastructure.

43. A communication network as claimed in claim 34 wherein the communication network comprises a cellular communications network.

44. A communication network as claimed in claim 34 wherein the communication network comprises a fixed network.

45. A node in a communication network arranged to:
transmit a request to determine if a condition is met for a first node during a provision of a service;
receive notification of whether said condition is met;
suspend the provision of the service if said condition is not met; and
resume the provision of the service when the condition is met.

46. A node as claimed in claim 45 wherein said node comprises at least one of a messaging center, content gateway, content provider and a session server.

47. A node as claimed in claim 45 wherein said condition comprises a payment condition.
